(19) United States
(12) Patent Application Publication
(10) Pub. No.: US 2018/0217981 A1
(43) Pub. Date: Aug. 2, 2018

(54) PERSONALITY-BASED REFINEMENT OF USER POSTINGS ON SOCIAL-MEDIA NETWORKS

(71) Applicant: International Business Machines Corporation, Armonk, NY (US)

(72) Inventor: Sarbajit K. Rakshit, Kolkata (IN)

(21) Appl. No.: 15/422,532

(22) Filed: Feb. 2, 2017

(51) Int. Cl. G06F 17/27; H04L 12/58; G06F 17/24; G06N 7/00

(52) U.S. Cl. CPC G06F 17/2785; G06N 7/005; G06F 17/24; H04L 51/32

(57) ABSTRACT

A method and associated systems for personality-based refinement of user postings on social-media networks. A communications-management system applies artificial intelligence, analytics, and psycholinguistics to generate a personality profile for each recipient network user capable of receiving content posted on the network. The system uses this profile to determine a probability that each user will respond to the posted content in an undesirable way. The system then reviews past postings by each recipient user to determine how extrinsic events influenced the way each recipient previously responded to online postings. After determining whether similar extrinsic events currently exist, the system predicts whether a proposed posting is likely to elicit an undesirable response. If the probability of such a response exceeds a preset threshold, the system automatically revises the posting, prior to posting it on the network, in order to mitigate the probability of an undesirable response.

### BACKGROUND

The present invention relates to managing social-media interactions and, in particular, to intercepting and modifying a user posting before it is posted as a function of personality-based predictions of user responses to the posting.

On a social network or other online communications forum, a user who posts content may be unpleasantly surprised by other users' reactions to that posting. Because online interactions often do not efficiently communicate body language, tone, and other non-verbal content, a posting user may not he aware of a recipient's general outlook on life, current mood, and other personality-based traits that may influence the recipient's reaction to the posting. It can thus be hard for the posting user to predict a probability of undesirable consequences to such a posting.

There is therefore a need for a way for a user to more objectively redict how other users are likely to respond to posted content.

### BRIEF SUMMARY

An embodiment of the present invention provides a communications-management system comprising a processor, a memory coupled to the processor, and a computer-readable hardware storage device coupled to the processor, the storage device containing program code configured to be run by the processor via the memory to implement a method for personality-based refinement of a user posting on a social-media network, the method comprising:

identifying a recipient user of the network capable of replying to postings made by a posting user of the network, where the posting user is distinct from the recipient user;

generating for the recipient user, by a first artificially intelligent analytics module comprised by the system, a psycholinguistic personality profile that comprises a probability that the recipient user will exhibit a particular personality trait when responding to postings made on the network;

receiving notice that the posting user intends to post a candidate posting on the network;

predicting, as a function of the psycholinguistic personality profile, a probability that the recipient user will post an undesirable response to the candidate posting; and

modifying, by a second artificially intelligent analytics module comprised by the system, the candidate posting, where the modifying lowers the probability that the recipient user will post an undesirable response to the candidate posting,

Another embodiment of the present invention provides method for personality-based refinement of a user posting on a social-media network, the method comprising:

a processor of a communications-management system identifying a recipient user of the network capable of replying to postings made by a posting user of the network, where the posting user is distinct from the recipient user;

the processor generating for the recipient user, by a first artificially intelligent analytics module comprised by the system, a psycholinguistic personality profile that comprises a probability that the recipient user will exhibit a particular personality trait when responding to postings made on the network;

the processor receiving notice that the posting user intends to post a candidate posting on the network;

the processor predicting, as a function of the psycholinguistic personality profile, a probability that the recipient user will post an undesirable response to the candidate posting; and

the processor modifying, by a second artificially intelligent analytics module comprised by the system, the candidate posting, where the modifying lowers the probability that the recipient user will post an undesirable response to the candidate posting.

Yet another embodiment of the present invention provides a computer program product, comprising a computer-readable hardware storage device having a computer-readable program code stored therein, the program code configured to be executed by a communications-management system omprising a processor, a memory coupled to the processor, and a computer-readable hardware storage device coupled to the processor, the storage device containing program code configured to be run by the processor via the memory to implement a method for personality-based refinement of a user posting on a social-media network, the method comprising:

the processor identifying a recipient user of the network capable of replying to postings made by a posting user of the network, where the posting user is distinct from the recipient user;

the processor generating for the recipient user, by a first artificially intelligent analytics module comprised by the system, a psycholinguistic personality profile that comprises a probability that the recipient user will exhibit a particular personality trait when responding to postings made on the network;

the processor receiving notice that the posting user intends to post a candidate posting on the network;

the processor predicting, as a function of the psycholinguistic personality profile, a probability that the recipient user will post an undesirable response to the candidate posting; and

the processor modifying, by a second artificially intelligent analytics module comprised by the system, the candidate posting, where the modifying lowers the probability that the recipient user will post an undesirable response to the candidate posting.

### BRIEF DESCRIPTION OF THE DRAWINGS

FIG. 1 shows the structure of a computer system and computer program code that may be used to implement a method for personality-based refinement of user postings on social-media networks in accordance with embodiments of the present invention.

FIG. 2 is a flow chart that illustrates the steps of a method for personality-based refinement of user postings on social-media networks in accordance with embodiments of the present invention.

FIG. 3A illustrates an example of a psycholinguistic personality profile that may be generated by methods of the present invention.

FIG. 3B continues the example of FIG. 3A.

### DETAILED DESCRIPTION

Online communications like email messages, Twitter tweets, timeline comments, Likes and Follows, audio and video content, and photo postings lack the nonverbal cues that add context and subtext to traditional real-time human interactions. :Furthermore, unlike other types of verbal, audio, and visual communication, online communications may be viewed instantly by large numbers of recipients who may then instantly respond.

A recipient who is normally argumentative, defensive, or even supportive may respond to a posting or other online communication in a way that is unexpected by or undesirable to the poster. And a recipient whose responses are generally predictable may react n an unexpected way if that recipient's current mood has been influenced by an extrinsic factor, such as a news item, a work-related issue, a family event, or a personal problem. On large social-media services such as Facebook or Twitter, a poster may not know who, or even how many people, will view a posting. All these uncertainties can increase the probability that an online communication may trigger an unexpected, undesirable response.

This problem is necessarily rooted in the technology of near-instantaneous, online, mass communication, which typically does not allow two parties to moderate communications by interactively exchanging nonverbal cues and feedback. Embodiments of the present invention address this technical problem with a technological solution that analyzes users' prior online activity to inter personality traits of each candidate recipient, and uses the resulting personality profiles to determine how recipients are likely to respond to a posting.

Embodiments further address this technical problem by considering extrinsic current events and determining how similar events had in the past affected a candidate recipient's online behavior. These steps are at least partially performed by technical means that may comprise online analytics, machine-learning algorithms, and other known methods of artificial intelligence.

Systems embodied by the present invention may then inform the candidate poster that, should a candidate communication be posted, certain users are likely to respond with undesirable communications of their own.

Some embodiments may perform this modification automatically, by using known methods of artificial intelligence to identify that a candidate posting has an unacceptably high probability of triggering an undesirable response, and to then automatically revise the posting to reduce that probability before the posting is posted.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection maybe made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

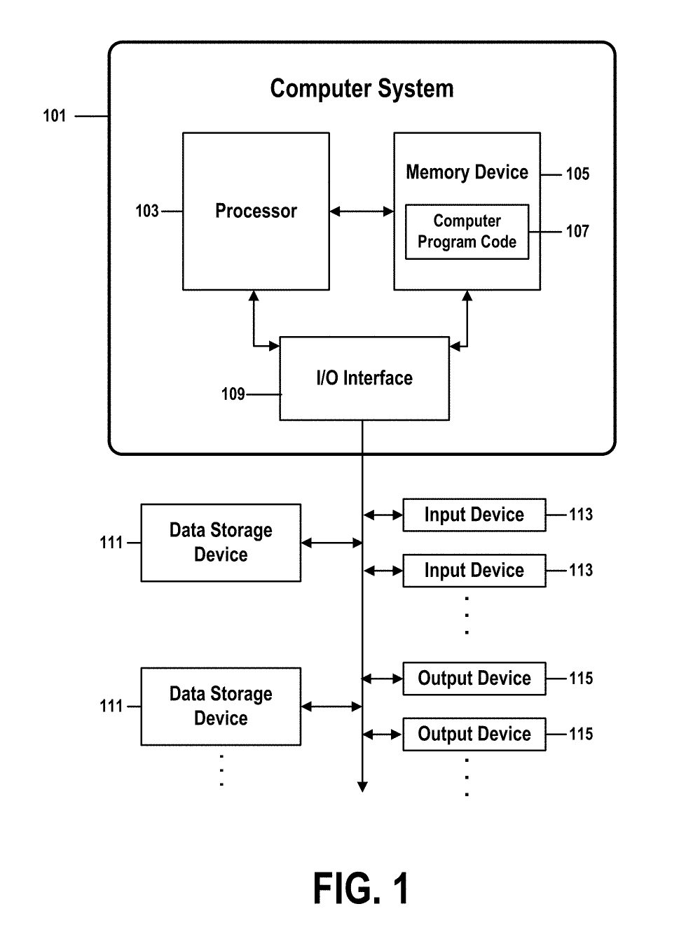

FIG. 1 shows a structure of a computer system and computer program code hat may be used to implement a method for personality-based refinement of user postings on social-media networks in accordance with embodiments of the present invention. FIG. 1 refers to objects 101-115,

In FIG, 1, computer system 101 comprises a processor 103 coupled through one or more I/O Interfaces 109 to one or more hardware data storage devices 111 and one or more 110 devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for personality-based refinement of user postings on social-media networks in accordance with embodiments of the present invention, and may implement other embodiments described in this specification, including the methods illustrated in FIGS. 1-3B. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, nonremovable, read-only storage medium such as a Read-Only Memory (ROM) device 105, or may be accessed by processor 103 directly from such a static, nonremovable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the present invention discloses a process for supporting computer infrastructure, integrating, hosting, maintaining, and deploying computer-readable code into the computer system 101, wherein the code in combination with the computer system 101 is capable of performing a method for personality-based refinement of user postings on social-media networks.

Any of the components of the present invention could be created, integrated, hosted, maintained, deployed, managed, serviced, supported, etc. by a service provider who offers to facilitate a method for personality-based refinement of user postings on social-media networks. Thus the present invention discloses a process for deploying or integrating computing infrastructure comprising integrating computer-readable code into the computer system 101, wherein the code in combination with the computer system 101 is capable of performing a method for personality-based refinement of user postings on social-media networks.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise the computer-readable hardware storage device.

While it is understood that program code 107 for a method for personality-based refinement of user postings on social-media networks may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for a method for personality-based refinement of user postings on social-media networks is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and, network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

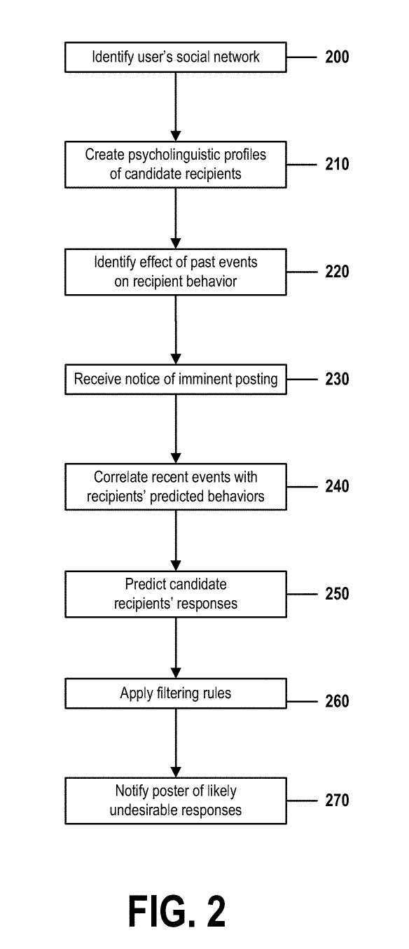

FIG. 2 is a flow chart that illustrates steps of a method for personality-based refinement of user postings on social-media networks in accordance with embodiments of the present invention. FIG. 2 comprises steps 200-270.

In step 200, a communications-management system identifies candidate recipient users of a social network who are capable of receiving electronic content posted online by a posting user. This content may comprise any sort of textual material, such as a text message, a text comment posted on a media Web site like YouTube, a text response to another user's posted content, or a question posed to another user. The content may also comprise graphical or multimedia content, such as a photograph, drawing, video clip, icon, emotion, or audio clip. In some embodiments, the content may comprise nonverbal indications, such as setting a “Like” flag for a user, a user's posting, or a topic; assigning a rating to a product offered for sale; “Following” another user or topic; or forwarding content previously posted by the user or by another user.

Embodiments may encompass any sort of content allowed by the communications platform through which the user posts, so long as it is possible to infer semantic meaning from the posting though known methods that may comprise artificial intelligence, semantic analytics, or text analytics. For example, meaning may be inferred from a text message by a known method of artificially intelligent semantic analytics or text analytics, or by identifying known keywords in the message.

Similarly, meaning may be inferred from metadata associated with verbal or nonverbal content. This metadata might, for example, identify a creator, subject matter, or genre of a video clip, an artist and genre of a musical excerpt, or a current event or public figure associated with a news article. Examples of metadata abound in the art, such as embedded MP3 tags, personally identifying information associated with a user account, or system-generated data like a time-stamp.

In other embodiments, meaning might be inferred by applying known methods of analysis to non-verbal content, such as by using facial-recognition technology to identify a public figure depicted in a photograph or by applying audio fingerprinting or other audio-analysis or forensics techniques like audio fingerprinting or watermarking to identify an artist, musician, instrument, genre, composition, or other characteristics of a musical recording, or to identify speakers, topics, sentiments, or other characteristics of a spoken-word audio recording.

The present invention is flexible enough to accommodate any known method of selecting candidate recipients. On a social network like Facebook, a posting user's candidate recipients may, for example, comprise other users identified by the posting user as Facebook “Friends.” On other platforms, candidate users might comprise users who have elected to “Follow” the posting user, or may comprise individuals authorized to respond to certain postings made to a particular Web site. In yet other examples, candidate users may comprise a set of users whitelisted or otherwise selected by the posting user or by one or more users who possess certain permissions, authorizations, security credentials, or other characteristics.

Certain embodiments may extend the examples of FIG, 2 to other types of online communities known in the art, such as BBS services, IRC rooms, intranet communities, email distribution lists, or public, private, or hybrid clouds. In all cases, such embodiments must comprise a way to select a set of recipient users of an online community who are likely to receive a posting user's posted communications.

In step 210, the system uses known methods of psycholinguistics to generate or update a psycholinguistic personality profile for some or all of the candidate recipients identified in step 200. In some embodiments, this step may be repeated from time to time as required to ensure that previously generated profiles have been updated with the most current information.

A candidate recipient user's profile will be generated or updated as a function of that user's previous online postings, using methods and technologies known in the art. Examples of such a method, known at the time that this patent application was filed, are described at http://venturebeat.com/2013/10/08/ibm-researcher-can-decipher-your-personality-in-200-tweets/ and https://www.fastcodesign.com/3025738/ibms-next-big-thing-psychic-twitter-bots, and may incorporate psycholinguistic profiling methods disclosed by issued U.S. Pat. Nos. 7,865,354 and 8,356,025 and published U.S. patent application 20150206102 A1. Such methods may use known techniques of artificial intelligence, text analytics, semantic analytics, and psycholinguistics to identify elements of a user's personality by analyzing the user's prior postings in one or more online communities.

These type of methods may require a relatively small number of postings—as little as 200 messages or 2500-3000 words—to produce a personality profile far more accurate than earlier methods of characterizing users by means of demographic data or personally identifying information. In some implementations, a profile may be created in part by correlating a user's phrasing or vocabulary of words with those of individuals who have in the past been analyzed by written personality tests.

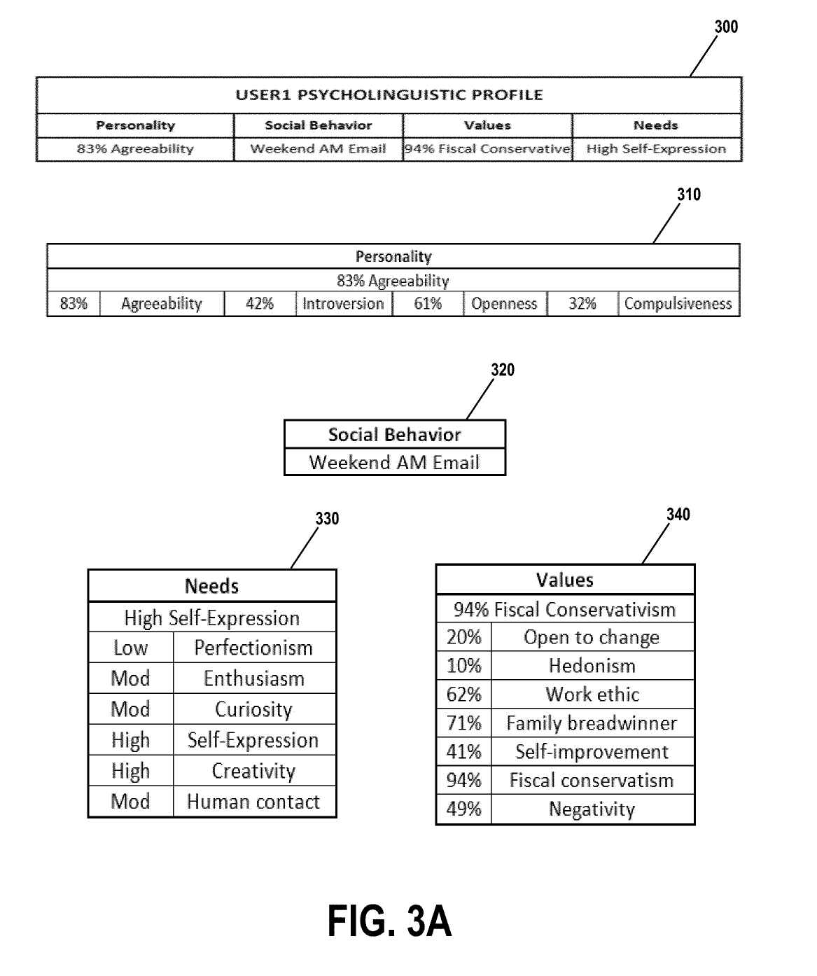

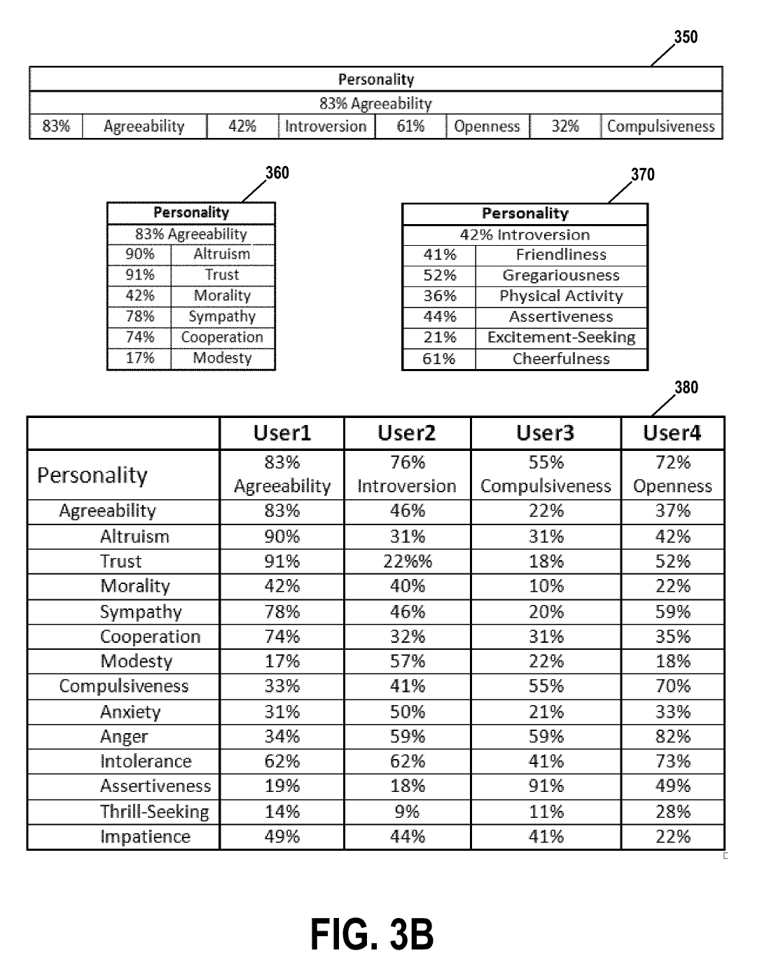

The resulting identifications may be organized into a user's “psycholinguistic profile” that can be formatted and used in a variety of ways. One such profile is illustrated in FIGS. 3A and 3B.

When created in accordance with embodiments of the present invention, a psycholinguistic personality profile may characterize a user's traits as one or more probabilities of responding in a certain manner to a certain type of posting.

For example, the exemplary profile of FIGS. 3A AND 3B organizes user traits into four categories that roughly correspond to values, needs, social behavior, and personality. Each of these categories may be divided into numerous sub-categories that may in turn divided into numerous traits. For example, “personality” might be divided into sub-categories Agreeability, introversion, Openness, and Compulsiveness, each of which might be further divided into traits, such as tendencies to anger, to experience anxiety, to hold politically conservative or liberal views, to be cautious, or to be orderly.

A particular user's personality profile associates each of these traits with a probability that the user will post an online posting that is influenced by a trait, such as an angry posting or a cautious posting. In some embodiments, a probability of a category or sub-category may be computed as an arithmetic function of the probabilities comprised by the category or sub-category or, as in the example of FIGS. 3A and 3B, a category or sub-category may be associated with the highest probability trait comprised by the category or sub-category.

A probability that a user's overall general attitude or personality comprises a particular trait or that a user posting will express the particular trait may be expressed as a rank, scaled number, per cent, tier, range, or other quantitative representation. Such probabilities may be aggregated to identify a probability that a user's personality may be best characterized as falling into one of the general categories or sub-categories. As described in FIGS. 3A AND 3B, a user's personality may then be expressed as a single number or a set of numbers that represents the probability that the user will exhibit behavior consistent with a particular general personality trait.

In certain embodiments, a personality profile may comprise multiple numbers that each identify a probability that a user will behave in a manner consistent with a different trait. FIGS. 3A and 3B describe examples of how such numbers might be generated. Embodiments of the present invention are flexible enough to accommodate any known expression of a psycholinguistic personality profile known in the art and any known method of generating such psycholinguistic profiles.

At the conclusion of step 210, the system ill have created a personality profile for each candidate recipient user. In some cases, the system will also create a similar profile for the posting user.

In step 220, the system fine tunes its characterization of each user by inferring from historical records the existence of extrinsic influences upon each candidate recipient user's response to prior postings. These historical records may comprise any information known in the art to be capable of identifying such responses, such as a user's text-message history, a listing of a user's emails or posted comments, a record of a user's previous Like, Unlike, Follow, or other selections, or any other sort of online communications, postings, or behavior.

Embodiments of the present invention may obtain and process these historic records by any means known in the art. For example, when operating within a social network that logs all user postings, the system may access a stored log. In other cases, the system may traverse the network in order to identify all communications posted by a particular user. On a network, the system may (generally with a subject user's authorization) intercept outgoing email messages sent from the subject user's email client or may retrieve from other users' inboxes incoming email messages sent by the subject user.

Regardless of which historic records are considered in this step, the system may then apply known methods of sentiment analysis in order to associate an emotional subtext with each record. Such known methods may, for example, comprise artificially intelligent text analytics or semantic analytics, or a less sophisticated approach such as keyword-matching. Such methods may identify vocabulary, syntactical constructs, or semantic meaning that is known to be associated with emotions or sentiments like anger, accommodation, support, impatience, or embarrassment.

Embodiments may accommodate any known method of translating these inferences into quantifiable rankings or probabilities. The communications-management system might, for example, identify how many postings made by each user are associated with a sentiment of anger. It might then rank the candidate recipient users in order of the number of angry postings made by each user, assigning a user with the greatest number of angry postings the first position in the ranking and assigning a user with the smallest number of angry postings the last position. Similar rankings might be created as functions of other inferred sentiments, such as agreement, enthusiasm, questioning, or confusion.

In other examples, each user might be assigned a number as a function of a number of user postings from which may be inferred a particular sentiment. For example, if a first user posts thirty supportive communications, a second user posts five supportive communications and a third user posts fifteen supportive communications, the three users might respectively be assigned relative weightings or “anger values” of thirty, five, and fifteen.

In other embodiments, these values may then be normalized, resulting in the three users being assigned respective values of 0.6, 0.1, and 0.3, These normalized values might also be interpreted as per cent values, probabilities, or probabilities of 60%, 10%, and 30%.

In a simple embodiment, users might be organized into ranges or categories as a function of the number of postings that are associated with a specific sentiment or that are associated with an intensity or magnitude of that sentiment that exceeds a predefined threshold. For example, users that have posted images or messages that may be characterized as comprising a subtext of “peacefulness” that exceeds a certain threshold may be ranked or sorted into groups as a function of how many such images or messages are associated with each user. In such an example, a first group of users might be characterized as “very peaceful,” a second group “moderately peaceful,” and a third group “slightly peaceful.”

The system may further narrow or categorize inferred sentiments by identifying correlations with other characteristics of a posting, with extrinsic events known to have occurred at a time associated with the posting, or with an extrinsic event known to have triggered the posting.

For example, an analytics or other procedure might track multiple types of angry postings made by a particular user, each of which is related to a different extrinsic trigger, such as work-related issues, traffic accidents, family problems, or political news. In such an embodiment, the system might identify a 4% overall probability that the particular user will post an angry posting, but a 25% that the user will post an angry response on a day during which the stock market has fallen more than 100 points.

Similarly, another embodiment might determine that certain subject matter comprised a posted message might increase the probability that the particular will post a humorous response. For example, the system might identify a 9% overall probability that the particular user will post a humorous image, but a 41% chance of posting a humorous image in response to viewing another user's posting about a certain public figure.

All of these examples are within the capability of known analytics and artificial-intelligent technologies, but these examples should not be construed to limit embodiments of the present invention of any single methodology. Embodiments of the present invention are thus flexible enough to accommodate any known method desired by a user or implementer that allows candidate recipient users to be ordered or ranked.

In step 230, the system receives notice that the posting user intends to post textual or non-textual content capable of being received by one or more of the candidate recipient users. This notice may be generated manually by the posting user by performing an action, such as clicking an onscreen button or by requesting that the system review the candidate posting before it is posted. In some embodiments, the system may automatically detect the candidate posting when the posting user completes the posting and clicks a button to send the posting. In all cases, the system will intercept the candidate posting before it can be posted in a manner that makes the posting visible to candidate recipient users. The system will then temporarily hold the posting until the system has a chance to predict likely responses to the posting.

In step 240, the system again uses artificially intelligent analytics modules or other software capable of inferring meaning from textual or non-textual data to identify current events that share similarities with events that were found in step 220 to correlate with specific user sentiments. This identification may be performed by any means known in the art, such as by analyzing a public news or weather feed, by monitoring internal company news, or by receiving information submitted by administrative personnel or by individual users.

As in earlier steps, this identification may be performed by any means known in the art, such as by applying artificially intelligent software, analytics applications, or keyword-matching, or by analyzing metadata.

The identification may, for example, be performed by using a facial-recognition application to identify a certain public figure in a visual or graphical posting that comprises a photograph or drawing, or by using a keyword search to identify the public figure's name in a textual posting or in metadata associated with a non-textual posting. In other cases, techniques of semantic analytics may be applied to infer semantic meaning from a news teed that describes passage of a particular type of federal law, where passage of other laws of that type had elicited a particular type of response from a candidate recipient user.

In other examples, similar means may be used to infer the existence of certain types of weather conditions by parsing output streamed from an online weather service, or to identify a release of a song or a movie associated with a particular artist, actor, composer, studio, record label, or director. If the system has access to a candidate recipient user's personal information, the system may in this step use any of the previously cited methods to identify or inter the existence of a particular type of family event, such as a birth, death, wedding, vacation, or house purchase that is known to have influenced the recipient user's postings in the past.

The system may then use this information to refine or replace the trait probabilities and behavioral predictions identified by the psycholinguistic personality profiles created in step 210 for each candidate recipient.

In one example, a first recipient user's generated personality profile may suggest that that there is an overall 3% chance that the user will post an angry private textual message in response to any other user's public posted message, but the historical analysis of step 240 may further assign the user a 12% chance of publicly posting an angry response if the stock market has fallen within the most recent trading day, and a 40% chance of posting an angry private response to any message that praises a certain type of fiscal policy. The system's analytics or AI modules will consider all these factors when predicting how the user will react to a particular posting.

If a condition has recently occurred that had been identified by the historical analysis as influencing or otherwise correlating with the recipient user's previous angry postings, then the historical analysis will be used to predict a probability of an angry response. But if no such condition has recently occurred, and no such correlations may be made with any current extrinsic event, the base personality profile will instead be used, thus predicting a default 3% chance of an angry response.

In some embodiments, this step may be performed at a different point in the flow chart of FIG. 2. For example, some embodiments may continuously track and consider current extrinsic events, so that when notification of an imminent posting is received in step 230, there will be no need to immediately perform what may be complex analytical procedures for a large number of candidate recipient users.

In step 250, the system uses the above analyses to predict each candidate recipient user's likely response to the message to be posted. This prediction may be performed by known means similar to those by which the candidate recipient user's historic postings were analyzed in steps 210-220. The posting user's proposed posting may, for example, be analyzed by an artificially intelligent semantic-analytics module, comprised by system, to determine whether the message comprises a type of content or sentiment that has in the past triggered undesirable or other types of responses from specific candidate recipient users.

In one example, a candidate recipient may have been identified as agreeing 70% of the time with postings that promote a certain type of sporting event. If the system in this step, by means of an analytics module, infers that the candidate posting would promote that type of sporting event, then that inference would be used to predict a 70% probability of that candidate recipient posting an agreeable response to the proposed posting. This 70% probability prediction would supersede any other probabilities that might be indicated by the candidate recipient user's less-specific psycholinguistic personality profile.

If a recipient user has been identified by the analysis of historical records in step 220 to have in the past posted content that correlates with a certain type of extrinsic event, the system will determine whether that type of event has occurred recently. In such cases, any time frame desired by an implementer may be arbitrarily chosen as being “recent,” such as a time frame that spans the previous 24 hours. Implementers may use their own judgement and knowledge of human nature to decide how long an event is likely to continue to influence a recipient user's mood.

In some cases, the definition of “recent” may have been determined empirically during step 220 as a function of a duration of time through which a previous occurrence of a specific type of event may have influenced a particular user's previous postings. For example, the system may have determined in step 220 that a winter blizzard had several years earlier affected a recipient user's attitude or mood such that the user's online responses to weather-related postings were 20% likely to be angry and 10% likely to be humorous during the first 12 hours after the blizzard, but 10% likely to be angry and 40% likely to be humorous during the next 12 hours.

If a blizzard has occurred 12 hours prior to receiving notification of an imminent posting in step 230, the system may then predict that the recipient is 20% likely to post an angry response and 10% likely to post a humorous response. Similarly, if the blizzard has occurred more than 12 hours prior, but less than 24 hours prior to receiving the notification in step 230, the system may instead predict that the recipient is 10% likely to post an angry response and 40% likely to post a humorous response.

In other examples, a prediction may be made if an extrinsic event s found to influence a recipient poster's postings in a way that cannot be straightforwardly correlated with a “recent” occurrence of the event. For example, a user may be found to be more likely to post a question in response to a finance-related posting if the stock market is currently more than 10% below its most recent trading high. This correlation nay exist regardless of how recently the market originally dipped below the 10% figure.

At the conclusion of step 250, the system will have generated a set of predictions, optionally expressed as probabilities, that each candidate recipient user will respond in a certain way to the proposed candidate posting. For example, it might predict that User #1 has a 10% chance of posting an angry response to the proposed posting, a 40% chance of agreeing with the candidate posting, and a 50% chance of responding with a joke related to the proposed posting. Some or all of these predictions may be made as a function of extrinsic events that have occurred within a time frame associated with the candidate posting or with the candidate recipient user. In some embodiments, the probabilities of each possible response may add up to more than 100%, since some responses may be characterized in more than one way, such as a posting that comprises an angry joke.

In step 260, the system may optionally apply filtering rules to reduce the size or number of notifications reported to the posting user. These rules may be developed by an implementer or submitted by a user, and they may apply to all users, to a certain subset of users, or to only a single user. These rules may also, in some embodiments, be applied automatically in order to determine whether to associate a candidate posting with an undesirably high probability of eliciting an undesirable response, or in order to identify a modification to the candidate posting that may be applied automatically by the system, with or without user confirmation, in order to reduce the probability that the posting will elicit an undesirable response.

These filtering rules may state that only certain types of user responses will be reported to the posting user. A user may, for example, create a rule that limits notifications to a specific range of possible responses that the user considers undesirable, or to a specific range of probabilities that such undesirable responses may he elicited, or may want to be notified of only certain types of undesirable responses posted by certain users. Such undesirable responses might, for example, comprise all angry or argumentative responses, or may include only angry responses posted by a manager or by coworkers within the posting user's workgroup or department.

In other examples, a filtering rule may filter out notifications of all undesirable responses that are less than 50% likely to occur or that are more likely to occur at the current time because of a recent occurrence of a certain extrinsic event. For example, in the previous blizzard-related example, a filtering rule that filters out notifications of a probability of an angry response that is lower than 10% might cause the system to omit notification of a higher probability of an angry response due to a blizzard, if that blizzard that had occurred more than 23 hours prior to the projected posting. In such a case, the posting user might have built in the one-hour buffer because the posting user would not normally expect to become aware of the angry response within an hour of the time when the response was posted. Many other examples are possible, and embodiments of the present invention are flexible enough to accommodate any such rule that might be deemed useful by a user or implementer.

In step 270, the system notifies the posting user of probable responses to the proposed posting, should that posting be posted without revision. In some embodiments, these responses may be communicated as a function of threshold probability levels, where a response is communicated to the posting user only if the system determines that the probability of receiving a specified type of undesirable response exceeds a specified probability threshold.

In embodiments that implement the filtering procedure of step 260, filtering rules may further decrease the number of predictions that will be communicated to the posting user. In some cases, the posting user will as a result of the filtering be notified in step 270 of only a small number of possible undesirable responses, where those responses are posted by only certain users or where those responses have a probability of occurring that satisfies other conditions, such as exceeding the threshold minimum probability of being posted by a recipient, or as being posted by the recipient within a certain time frame.

The system in this step may display or format the notifications in any known manner desired by implementers. The notifications may, for example, be displayed as numeric per centages, as bar charts, or as other types of graphical representations, or may be presented as a simple listing of candidate recipient users who are each associated with a probability of posting an undesirable response that exceeds an probability threshold value selected by the user or set by an implementer or system administrator.

The posting user may then review the notifications and confirm the posting user's desire to post the posting intact. The posting user may also decide to cancel the posting and revise the candidate message. In such a case, steps 220-270 might then repeat as necessary if a new set of predictions are to be made, and this iterative procedure of steps 220-270 would continue to be repeated until the user is satisfied that the proposed posting will not be met with an unacceptable set of undesirable responses.

In some embodiments, the method of FIG. 2 may be extended to consider multiple probabilities when predicting a probability that a candidate recipient user may respond in a. certain way. If, for example, the analyses of steps 210-250 may indicate a 30% chance that a particular candidate recipient user will respond in an angry manner and a 20% chance that the recipient will respond with a humorous message. In some embodiments, the system might then report both probabilities to the posting user, but in others, the system might instead report only the most likely probability of a particular recipient user's multiple probabilities, or might, before reporting the most likely probability, revise the most likely probability to account for the possibility that less likely responses might occur.

For example, the system may have inferred a 50% probability that a particular recipient user will respond with a negative, argumentative response to the candidate posting, but a 20% probability that the recipient user will agree with the candidate posting. In such a case, an embodiment might report only the highest probability (50% probability of an argumentative response from the recipient user), or might first discount that probability as a function of the less-likely probability. The resulting notification might thus identify a 30% probability of a negative response (50%-20%) or a 40% probability of a negative response (50%*(100%-20%)). Embodiments of the present invention may accommodate any other sort of method of discounting or combining multiple probabilities, as desired by an implementer.

In some embodiments, the system may automatically revise the proposed posting in order to mitigate or eliminate elements that triggered some or all of the predicted undesirable responses. This step may be performed by any known means similar to those by which candidate recipient users' historic postings could be analyzed in steps 210-220,

In one example, the proposed candidate posting might have been analyzed by an artificially intelligent semantic-analytics software module in step 250 to determine that the posting comprises a particular semantic meaning or comprises content that the system has correlated with a certain type of undesirable response from a certain recipient user. In response to that determination, the system might in this step highlight words from which the correlated meaning was inferred, or may automatically replace those words with more neutral language. The system might then give the user an opportunity to either accept the changes or to manually revise the proposed posting.

In some embodiments, the system may operate as an automatic content-refining mechanism, automatically revising a proposed posting to minimize the probability that other uses will post undesired responses. In such cases, the user may be given veto power over the system's proposed changes, but in certain embodiments, the system may automatically perform, without further user interaction, the entire procedure of analyzing the proposed posting, identifying probabilities of undesirable responses, modifying the posting to mitigate those probabilities, and then posting the proposed content.

In many embodiments, the performance of these steps may be all or partly managed by user-defined or implementer-defined rules similar to those described in step 260. A user might, for example, define rules specifying that the system automatically revise messages that will be visible to certain candidate recipient users, or might define rules setting different threshold probabilities for certain candidate recipient users that the posting user might consider especially sensitive to specific types of posted content or extrinsic events.

FIG. 3A shows an example of a psycholinguistic personality profile that ay be generated by methods of the present invention.

Item 300 shows a top-level summary of a user's psycholinguistic personality profile. Each such profile in the example of FIGS. 3A and 3B is a hierarchical structure, where each field of each row is comprised of lower-level rows. Each field comprises two elements: an identification of a user trait and a probability that that trait will be expressed in an online posting made by the user.

For example, item 300 identifies that a User1 is associated with traits that fall into four categories: “Personality,” “Social Behavior,” “Values,” and “Needs.” Although this categorization is known in the art, the concept of psycholinguistic personality profiles is flexible enough to accommodate other types of categorizations.

Although not shown in the figure, it is possible to summarize User1's personality profile as a single trait and probability, where that trait and probability are selected from the traits and probabilities identified by the four categories. In a simple case, where the trait with the highest probability is selected, User1 might thus be characterized as “94% Fiscal Conservative.”

In other embodiments, implementers might choose to user other methods of selecting one of multiple traits or might report the highest-probability trait of each of the four categories.

In some cases, probabilities may be shown as per centages, as shown in the “Personality” and “Values” categories of profile 300. In other cases, a probability may be represented as a binary value (either “probable” or “not probable”) or as one of a set of non-numeric relative values, such as the “High,” “Moderate,” and “Low” values associated in example with traits of the “Needs” category.

Item 310-340 show contents of the profile one level below the top-level of item 300. In other words, item 310 shows the sub-categories of traits that make up the “Personality” category, item 320 shows the trait that makes up the “Social Behavior” category, item 330 shows the sub-categories of traits that make up the “Needs” category, and item 340 shows the sub-categories of traits that make up the “Values” category.

For example, item 340 enumerates traits comprised by the “Values” category that include “openness to change,” “hedonism,” “work ethic,” “assumption of responsibility to support a family,” “a desire for self-improvement,” “fiscal conservatism,” and “negativity.” Each of these traits is associated with a probability that User1 will exhibit such a trait when posting an online message, or that such a posting will be influenced by such a trait.

As can be seen in item 340, methods similar to those described in item 300 may be used to represent User1's values by a single trait and probability. In this simple example, the highest-probability trait (“fiscal conservatism”) is selected to represent “Values” category of User1's profile.

Other types of representations are possible. For example, the Social Behavior table 320 enumerates specific user behaviors, such as a habit of posting email messages during the morning on weekends. Although only one such behavior is shown in the example of FIG. 3A, real-world implementations may comprise many such behaviors, each of which is associated with a probability of occurrence.

In another example, User1's social needs are represented in Needs table 330 as being comprised of a variety of emotional needs, such as a need for perfectionism, creativity, or human contact. In the example of FIG. 3A, User1's “Needs” category is represented by one of the highest-probability trait listed in Needs table 330.

In all cases, if two traits are associated with the same highest probability, the system will resolve the conflict in any way deemed suitable by an implementer or by a user. These ways may, for example, comprise selecting either trait at random, reporting both traits, reporting an aggregate trait that combines the two equal-probability traits, or considering more complex rules that might, for example, flag certain traits or certain traits of certain users as taking precedence over traits. In Needs table 330, for example, both “Self-Expression” and “Creativity” are associated with the highest possible probability. Self-Expression, however, has been selected to represent the “Needs” sub-category because of a previously defined filtering rule that, as a function of step 240's historic analysis of User1, ranks User1's need for self-expression to be more important than User1's need for creativity.

These decisions may be under the complete control of users and implementers, and embodiments of the present invention are flexible enough to accommodate any such rules that may be desired by a user or implementer.

FIG. 3B continues the example of FIG, 3A, illustrating a psycholinguistic personality profile that may be used by methods of the present invention. FIG. 3B references items 350-380.

Item 350 is identical in form and function to the “Personality” table 310 of FIG. 3A and is repeated in FIG. 3B solely for purposes of clarity.

As in the hierarchical tables 300-340 of FIG. 3A, FIG. 3B shows part of a hierarchy of categories, sub-categories, and traits that result in a “Personality” characterization of “83% Agreeability” shown in Personality table 310 and 350, and summarized in the profile's top-level table 300.

In this case, Personality traits are organized in table 350 into four categories: “Agreeability,” “Introversion,” “Openness,” and “Compulsiveness.” As with all tables shown in FIGS. 3A and 3B, these exemplary categorizations should not be construed to limit embodiments of the present invention to single fixed set of categories. Implementers are free to select other traits, categories, and sub-categories as they see fit.

Tables 360 and 370 show two lower levels of traits that respectively comprise the “Agreeability” and “Introversion” sub-categories of the “Personality” category shown in table 350. “Agreeability” table 360, for example, lists probabilities for each of the traits that are fall into the “Personality” category, such as altruism, trust, or modesty. Similarly, “Introversion” table 370 lists probabilities for each of the traits that are make up the “Introversion” category, such as friendliness, assertiveness, or gregariousness.

In general embodiments of the present invention, psycholinguistic personality profiles may comprise different sets of categories, sub-categories, and traits, and may comprise a greater or lesser number of hierarchical levels of categorization.

Items 380 shows part of an optional tabulation of the top-level results of multiple users' psycholinguistic profiles. In real-world implementations, this table 380 may comprise a row for every trait, organized by category or sub-category, or may be limited to a certain number of levels. For example, one embodiment may include only a single top-level summary probability, while another may include four rows for each candidate recipient user, respectively corresponding to the four categories of table 300.

Table 380 may never be displayed to a posting user, and may instead be used internally in order to rank candidate recipient users by each tracked trait, category, or sub-category. In some cases, this ranking may be used to determine when a probability exceeds a threshold limit. Such an implementation might, for example, report only the top two, or the top one-quarter of recipient users associated with a nonzero probability of posting a certain type of trait-influenced undesirable response, where those recipient users are ordered or ranked by each recipient user's probability of posting such a response.

In some embodiments, a user ranking as shown in table 380 may not be required and such a table may not be implemented.

In the example of FIG. 3B, table 380 may produce a warning that User3 has a 55% chance of responding in a compulsive manner to the candidate posting. In some embodiments, the system may not report the agreeable, introverted, or open responses likely to be posted by User1, User2, and User4 if those types of responses have not been deemed by a rule, by the user, or by an implementer to be undesirable. In other embodiments that do not have such rules, all four recipient users' responses may be reported to the posting user. Embodiments of the present invention are flexible enough to accommodate any variation of these rules and constraints that may be desired by an implementer.

1. A communications-management system comprising a processor, a memory coupled to the processor, and a computer-readable hardware storage device coupled to the processor, the storage device containing program code configured to be run by the processor via the memory to implement a method for personality-based refinement of a user posting on a social-media network, the method comprising:
identifying a recipient user, where the recipient user is one user of a plurality of users of the network who are each capable of replying to postings made by a posting user of the network, and where the posting user is distinct from the recipient user;
generating for the recipient user, by a first artificially intelligent analytics module comprised by the system, a psycholinguistic personality profile that comprises a probability that the recipient user will exhibit a particular personality trait when responding to postings made on the network;
receiving notice that the posting user intends to post a candidate posting network;
predicting, as a function of the psycholinguistic personality profile, a probability that the recipient user will post an undesirable response to the candidate posting; and
modifying, by a second artificially intelligent analytics module comprised by the system, the candidate posting, where the modifying lowers the probability that the recipient user will post an undesirable response to the candidate posting.

2. The system of claim 1, where the generating comprises performing a sentiment analysis upon previous postings made on the network by the recipient user.

3. The system of claim 1, further comprising:
correlating, by a third artificially intelligent analytics module comprised by the system, the recipient user's previous postings with one or more extrinsic events, where the correlating comprises identifying an influence exerted by at least one of the extrinsic events on a previous posting of the recipient user.

4. The system of claim 3, where the predicting further comprises:
identifying, by a fourth artificially intelligent analytics module as a function of the correlating, extrinsic events capable of currently influencing the recipient's response to the candidate posting, where the predicting is a function of the correlating and of the identified extrinsic events.

5. The system of claim 1, where the predicting further comprises performing, by a fifth artificially intelligent analytics module comprised by the system, a candidate sentiment analysis upon the candidate posting, where the candidate sentiment analysis infers semantic meaning and emotional content from the candidate posting.

6. The system of claim 1, where the recipient's posted response is deemed to be undesirable when a sixth artificially intelligent analytics module comprised by the system infers that the recipient's posted response comprises a sentiment that was previously deemed to be undesirable by the posting user.

7. The system of claim 1, where a first posting posted by a first network user comprises any sort of textual, graphical, audio, or video content from which an artificially intelligent analytics program is capable of inferring influence on the first posting by a personality trait of the first network user.

8. The system of claim 1, where the modifying comprises:
notifying the posting user, by the second artificially intelligent analytics module, of a high probability that posting the candidate posting will induce the recipient user to post an undesirable response, where the high probability is any probability that exceeds a predefined maximum threshold probability;
suggesting to the posting user, by the second artificially intelligent analytics module, a modification to the candidate posting that would reduce the probability that posting the candidate posting will induce the recipient user to post an undesirable response;
receiving authorization from the posting user to modify the candidate posting;
modifying the candidate posting; and
posting the modified candidate posting.

9. A method for personality-based refinement of a user posting on a social-media network, the method comprising:
a processor of a communications-management system identifying a recipient user, where the recipient user is one user of a plurality of users of the network who are each capable of replying to postings made by a posting user of the network, and where the posting user is distinct from the recipient user;
the processor generating for the recipient user, by a first artificially intelligent analytics module comprised by the system, a psycholinguistic personality profile that comprises a probability that the recipient user will exhibit a particular personality trait when responding to postings made on the network;
the processor receiving notice that the posting user intends to post a candidate posting on the network;
the processor predicting, as a function of the psycholinguistic personality profile, a probability that the recipient user will post an undesirable response to the candidate posting; and
the processor modifying, by a second artificially intelligent: analytics module comprised by the system, the candidate posting, where the modifying lowers the probability that the recipient user will post an undesirable response to the candidate posting.

10. The method of claim 9, where the generating comprises performing a sentiment analysis upon previous postings made on the network by the recipient user.

11. The method of claim 9, further comprising:
correlating, by a third artificially intelligent analytics module comprised by the system, the recipient user's previous postings with one or more extrinsic events, where the correlating comprises identifying an influence exerted by at least one of the extrinsic events on a previous posting of the recipient user; and
identifying, by a fourth artificially intelligent analytics module as a function of the correlating, extrinsic events capable of currently influencing the recipient's response to the candidate posting, where the predicting is a function of the correlating and of the identified extrinsic events.

12. The method of claim 9, where the predicting further comprises performing, by a fifth artificially intelligent analytics module comprised by the system, a candidate sentiment analysis upon the candidate posting, where the candidate sentiment analysis infers semantic meaning and emotional content from the candidate posting.

13. The method of claim 9, where the recipient's posted response is deemed to be undesirable when a sixth artificially intelligent analytics module comprised by the system infers that the recipient's posted response comprises a sentiment that was previously deemed to be undesirable by the posting user.

14. The method of claim 9, where the modifying comprises:
notifying the posting user, by the second artificially intelligent analytics module, of a high probability that posting the candidate posting will induce the recipient user o post an undesirable response, where the high probability is any probability that exceeds a predefined maximum threshold probability;
suggesting to the posting user, by the second artificially intelligent analytics module, a modification to the candidate posting that would reduce the probability that posting the candidate posting will induce the recipient user to post an undesirable response;
receiving authorization from the posting user to modify the candidate posting;
modifying the candidate posting; and
posting the modified candidate posting.

15. The method of claim 9, further comprising providing at least one support service for at least one of creating, integrating, hosting, maintaining, and deploying computer-readable program code in the computer system, wherein the computer-readable program code in combination with the computer system is configured to implement the identifying, the generating, the receiving, the predicting, and the modifying.

16. A computer program product, comprising a computer-readable hardware storage device having a computer-readable program code stored therein, the program code configured to be executed by a communications-management system comprising a processor, a memory coupled to the processor, and a computer-readable hardware storage device coupled to the processor, the storage device containing program code configured to be run by the processor via the memory to implement a method for personality-based refinement of a user posting on a social-media network, the method comprising:
the processor identifying a recipient user, where the recipient user is one user of a plurality of users of the network who are each capable of replying to postings made by a posting user of the network, and where the posting user is distinct from the recipient user;
the processor generating for the recipient user, by a first artificially intelligent analytics module comprised by the system, a psycholinguistic personality profile that comprises a probability that the recipient user will exhibit a particular personality trait when responding to postings made on the network;
the processor receiving notice that the posting user intends to post a candidate posting on the network;
the processor predicting, as a function of the psycholinguistic personality profile, a probability that the recipient user will post an undesirable response to the candidate posting; and
the processor modifying, by a second artificially intelligent analytics module comprised by the system the candidate posting, where the modifying lowers the probability that the recipient user will post an undesirable response to the candidate posting.

17. The computer program product of claim 16, where the generating comprises performing a sentiment analysis upon previous postings made on the network by the recipient user.

18. The computer program product of claim 16, further comprising:
correlating, by a third artificially intelligent analytics module comprised by the system, the recipient user's previous postings with one or more extrinsic events,where the correlating comprises identifying an influence exerted by at least one of the extrinsic events on a previous posting of the recipient user; and
identifying, by a fourth artificially intelligent analytics module as a function of the correlating, extrinsic events capable of currently influencing the recipient's response to the candidate posting, where the predicting is a function of the correlating and of the identified extrinsic events.

19. The computer program product of claim 16, where the predicting further comprises performing, by a fifth artificially intelligent analytics module comprised by the system, a candidate sentiment analysis upon the candidate posting, where the candidate sentiment analysis infers semantic meaning and emotional content from the candidate posting.

20. The computer program product of claim 16, where the modifying comprises:
notifying the posting user, by the second artificially intelligent analytics module, of a high probability that posting the candidate posting will induce the recipient user to post an undesirable response, where the high probability is any probability that exceeds a predefined maximum threshold probability;
suggesting to the posting user, by the second artificially intelligent analytics module, a modification to the candidate posting that would reduce the probability that posting the candidate posting will induce the recipient user to post an undesirable response;
receiving authorization from the posting user to modify the candidate posting;
modifying the candidate posting; and
posting the modified candidate posting.
